(19) United States
(12) Patent Application Publication
(10) Pub. No.: US 2023/0325863 A1
(43) Pub. Date: Oct. 12, 2023

(54) INCORPORATING DIGITAL TOKENS INTO MULTI-WAVE USER STRUCTURES

(71) Applicant: KwikClick, LLC, Murray, UT (US)

(72) Inventor: Fred Cooper, Farmington, UT (US)

(21) Appl. No.: 18/130,788

(22) Filed: Apr. 4, 2023

Related U.S. Application Data
(60) Provisional application No. 63/330,189, filed on Apr. 12, 2022.

(51) Int. Cl. G06Q 30/0207

(52) U.S. Cl. CPC G06Q 30/0209

(57) ABSTRACT

Systems and methods are provided for integrating digital tokens into a dynamic multi-wave user structure that tracks related online interactions with digital intangible objects. Such user structures may be dynamically updated in accordance with code-based tracking of online gaming token usage at linked websites (or web applications). Each token code may be uniquely identify each user (and any related upline users) and be embedded in a link to the website. An online request may be sent from a user device using an online web application when such a link is activated. The resulting online activity may thereafter be identified as being associated with the user associated with the embedded code (and their respective upline users). The online activity may include, for example, play of an online game and may result in rewards not only for the playing user, but also distributed to the user associated with the embedded code and any upline users.

### CROSS-REFERENCE TO RELATED APPLICATION

The present application claims the priority benefit of U.S. provisional application No. 63/330,189 filed Apr. 12, 2022, the disclosure of which is incorporated herein by reference.

### BACKGROUND OF THE INVENTION

### Field of the Invention

The present disclosure is generally related to multi-level user structures. More specifically, the present disclosure is directed to integrating digital tokens into multi-wave user structures that track online activities based on unique codes embedded in associated web links

### Description of the Related Art

Multi-level marketing (MLM) systems is a sales strategy used by some direct sales companies, which encourages existing distributors to recruit new distributors who are paid a percentage of their recruits' sales. The recruits are the distributor's “downline.” Distributors also make money through direct sales of products to customers. Amway, which sells health, beauty, and home care products, is an example of a well-known direct sales company that uses multi-level marketing.

Multi-level marketing is a legitimate business sales strategy. One problem with traditional MLM systems is that the MLM is organized as a pyramid tree. However, pyramid “schemes” that use money from new recruits to pay people at the top rather than those who perform the work are illegal. These pyramid schemes involve taking advantage of people by pretending to be engaged in legitimate multi-level or network marketing. You can spot pyramid schemes by their greater focus on recruitment than on product sales.

One issue in determining the legitimacy of a multi-level marketing company is whether it sells its products primarily to consumers or to its members, who must recruit new members to buy their products. If it is the former, the company is likely a legitimate multi-level marketer. If it is the latter, it could be an illegal pyramid scheme.

Although each MLM company dictates its own specific financial compensation plan for the payout of any earnings to their respective participants, the common feature across all MLMs is that the compensation plans theoretically payout to participants only from two potential revenue streams. The first is paid out from commissions of sales made by the participants directly to their retail customers. The second is paid out from commissions based upon the wholesale purchases made by other distributors below the participant who have recruited those other participants into the MLM; in the organizational hierarchy of MLMs, these participants are referred to as one's downline distributors.

Therefore, MLM salespeople (distributors) are expected to sell products directly to end-user retail consumers through relationship referrals and word-of-mouth marketing. Still, most importantly, they are incentivized to recruit others to join the company's distribution chain as fellow salespeople to become downline distributors.

Currently, to join an MLM, there is an initiation fee, which is a barrier against those who wish to refer a single product they like. Current multi-level marketing (MLM) systems do not take full advantage of the internet and how consumers can influence other consumers to make purchases. Also, current MLM systems do not incorporate incentivizing users of a multi-level marketing system by offering a dynamic commission tree. In addition, there is no current MLM system that utilizes the money or funds dedicated to discounts or coupons to be reincorporated into a multi-level marketing system to incentivize consumers to make purchases and advertise the product they purchased.

MLMs are not designed to distribute intangible goods, such as entry into games of chance. Nor are MLMs designed to increase traffic to an application or website. This limitation of current MLMs prevents them from being used to incentivize participation in online or other digital games, including those games that use digital tokens as part of in-game activities.

Conversely, presently available systems for managing online and other digital games do not track the relationships between different online users so as to be able to identify which users may be responsible for certain online activities or actions of other users. Nor do most digital games track multiple levels of upline or downline users that may have contributed to another user's participation and activity.

There is therefore a need in the art for improved system and methods of incorporating digital tokens into multi-wave user structures.

### BRIEF DESCRIPTION OF THE DRAWINGS

FIG. 1 illustrates a system for multi-level marketing of products via a set of computing devices.

FIG. 2 illustrates a method that may be performed by a computer that performs functions consistent with the administration network computer of FIG. 1.

FIG. 3 illustrates a method that may be performed at a user device of FIG. 1 when operations of a multi-level-management system consistent with the present disclosure are performed.

FIG. 4 illustrates a method that may be performed by a computer at the third-party network computer of FIG. 1.

FIG. 5 illustrates a method that may be performed by the administration network computer 110 executing the gambling program instructions of FIG. 1.

FIG. 6 illustrates a computing system that may be used to implement an embodiment of the present invention.

### SUMMARY OF THE CLAIMED INVENTION

Embodiments of the present invention include systems and methods for incorporating digital gambling tokens into multi-wave user structures. In exemplary embodiments, a user interacts with a digital intangible product (e.g., a wager or entry into an online game of chance) that is registered with an administration network. The buyer then automatically becomes a user (user A) within a dynamic user structure maintained by the administration network. The administration network generates a token code (code A) that is associated with user A, who may be assigned or have selected a reward distribution plan. Another buyer may interact with the same digital intangible product, and in the process, uses code A as part of the online interaction. The second buyer also automatically becomes incorporated into the user structure (as user B) of the administrative network. The administration network generates different token code (code B) that is associated with user B and with code A. User B is assigned or selects a reward distribution plan. The user A is awarded a reward based on the reward distribution plan assigned to or selected by user A because user B used code A. Such rewards may include points, awards, badges, voucher, gift, commissions, etc., that may be tracked within the dynamic user structure in real-time with the online activity occurring at linked websites associated with a code.

Online interactions may include various selections or actions taken at a designated website, and such online interactions may be associated with a code embedded in a link used to access the designated website. For example, another buyer may transact an online purchase of the same intangible product using the token code associated with user B, code B. The third buyer also automatically becomes a user (user C) of the administration network. The administration network generates different token code (code C) that is associated with user C and code B. Both user A and user B are awarded commission based on a reward distribution plan (e.g., commission plan) assigned to or selected by user A and user B respectively because user C used code B, which is associated with code A.

Alternatively, a computer that is part of an administration network receives a notification that a buyer has purchased an intangible product registered with the administration network. The computer then identifies the buyer as a user (user A). The computer generates a token code (code A) that is associated with user A. The computer assigns or allows user A to select a commission plan. The computer receives a notification that another buyer has purchased the same intangible product, and the notification includes code A. The computer then identifies the second buyer as a user (user B). The computer generates a different token code (code B) that is associated with user B and code A. The computer assigns or allows user B to select a commission plan. The computer awards commission to user A based on the commission plan assigned to or selected by user A because the notification included code A. The computer receives a notification that another buyer has purchased the same product, and the notification includes code B. The computer then identifies the third buyer as a user (user C). The computer generates a different token code (code C) that is associated with user C. The computer awards commission to both user A and user B based on the commission plan assigned to or selected by user A and user B, respectively, because the notification included code B, which is associated with code A.

### DETAILED DESCRIPTION

The present disclosure is directed to a system and method to allow intangible products, like digital products pertaining to games of chance, to be integrated into a multilevel (or multi-wave) user data structure that tracks related online activity. For example, where an online object (e.g., good or service) is offered by an online website, and an online user interacts with the digital object and contributes to the interaction of another user, who is then automatically tracked as a contributor to downstream users' online activities. Each user has a unique code tied to the specific online products offered by the respective website(s). The code may shared by this first user passively (e.g., triggered by or otherwise associated with online actions and interactions) or actively (by request) to a new user. The code share makes the new user a part of a dynamic user structure. The new user, like the first, will be allowed to interact with the online product and provide referrals (e.g., share advertisements) to other online users. Rewards distributed to respective downline purchasers for a single product may be limited by a present number of defined levels. After a product is purchased, rewards (including commission-based rewards) are paid out to each respective purchaser according to the defined reward distribution levels.

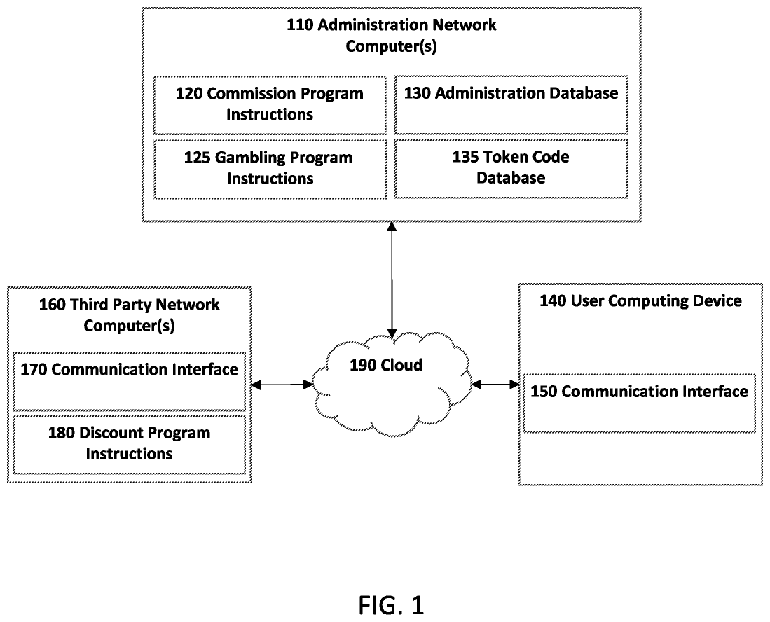

FIG. 1 illustrates a system for multi-level marketing of products, including intangible products (e.g., games of chance, tokens, wagers). This system may be comprised of administration network computer (“Admin Network”) 110, which may include a base module, calculation module, commission module, advertising module, admin database, vendor module, compensation database, and administration code database. Each of the devices of FIG. 1, administration network computer 110, user device 140, and third-party network computer(s) 160 may communicate with each other via a communication network, such as cloud 120 or the Internet.

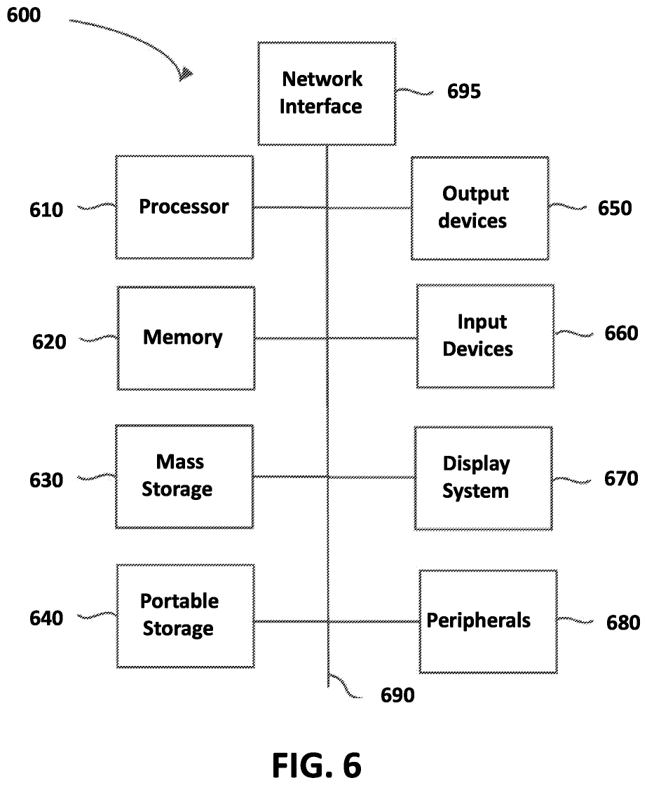

A memory, as shown in FIG. 6, at the administration network computer 110 may store commission program instructions 120 executed by a computer processor, and an administration database 130. User device 140 of FIG. 1 may be any user device such as a laptop, smartphone, tablet, computer, or smart speaker which may include a user device communication interface 150 which may be a network interface as shown in FIG. 6. The third-party network computer 160 of FIG. 1 may include discount program instructions 170 executed by a computer processor, a memory, and a communication interface 150 which may be a network interface.

Use of the system may be as follows. A user connects a user device 140 to the communication network 190 via the user device communication interface 150. Through the communication network 190 the user device 140 connects with the third-party network computer 160 via the third-party network communication interface 170. A set of third-party network discount program instructions 180 allow the user to purchase a product from the third-party network computer 160 and apply a discount to the product if a user has a token code. Confirmation of the purchase and the token code are then sent from the third-party network computer 160 to the administration network computer 110. If the user did enter a token code, a set of administration network commission program instructions 120 will pay commission to at least another user that is associated with the token code based on the commission plan assigned to or selected the user. A new token code is then generated by the administration network computer 110 per the administration network commission program instructions 120. The new token code is associated with the user of the user device 140. The commission and the newly generated token code are stored in the administration network administration database 130. The administration network computer 110 or the user may select or generate a commission plan for a new user. The selected or created plan is then assigned to or suggested to the user.

Program code instructions of the administration network computer 110 may be organized as one or more software modules that include instructions for performing different functions. For example, a set of commission program instructions 120 may include base program instructions, advertising program instructions, calculation program instructions, and vendor program instructions. Administration network computer 110 may also access one or more databases, such as a compensation database that stores compensation data and a database that stores program code or web link data, for example. The administration network computer 110 may accept sellers (third parties), where a “single product tree” multi-level marketing method is formed, comprising the steps of, providing at least one intangible product, providing an MLM system with a seller's commission structure, and providing at least one seller of an intangible product with its associated commission structure. The term “single product tree” refers to a unique structure for associating distributors of an MLM organization where intangible products are used to identify relationships between distributors and commissions paid to related distributors. This “single product tree” structure allows for a particular user to be considered a sponsor or any other user based on that user sending promotions to other users to purchase an intangible product that those other users were not previously associated with.

The administration network computer 110 may also provide a plurality of buyers/distributors, allow the at least one first seller to enroll an intangible product to the MLM system, and allow at least a first buyer/distributor to purchase the intangible product. Other functions that may be performed by the administration network computer 110 include allowing the at least the first buyer/distributor to advertise the intangible product to other potential buyers/distributors and allowing at least a second buyer/distributor to buy the advertised intangible product. Here the seller may set a commission structure for an intangible product, may enroll the product into the MLM system, may allow the first, second and so on purchasers/distributors to purchase and advertise the intangible product.

Once intangible products have been enrolled with a commission structure, the administration network computer 110 may allow the purchasers/distributors to receive a commission based upon the seller's product commission structure. A distributor may refer to the non-salaried workforce selling the company's intangible products. Here, the earnings of the participants may be derived from a pyramid-shaped or binary compensation commission system. The term intangible product may refer to an entry into a game of chance, such as a wager, spin on a prize wheel, a slot machine entry, a bet, any combination thereof, or the like. Intangible product may refer to an individual product, a series of intangible products associated with a particular game, a series of intangible products associated with a particular location or third-party, any combination thereof, or the like.

The system 100 of FIG. 1 may distribute commissions according to an MLM tree or commission tree that is a payment structure in which commissions are given out at different percentages at different levels of the MLM tree, for example. In such a system distributor (users) that perform the sale or that are at a level that is “closer” to the distributor that performed the sale may receive larger commissions than distributors that are “farther” from the sale.

In another example, a first MLM distributor that performs a sale may receive a higher percentage than a second distributor that sponsored the first distributor, and a third distributor that signed up the second distributor may receive a lower commission than the commission received by the second distributor for the sale. Distributors in an MLM tree may be referred as “downline” or “upline” distributors depending on where different users rank on the MLM tree. For example, a first user that sponsors a second user is “upline” from the second user and the second user is “downline” from the first user in the MLM tree. Furthermore, any user/distributor that the second user sponsored would be considered downline from the second user and could be downline from the first user as well for a given MLM product tree. When a “single product tree” structure is used to identify commissions, users that are downline from the second user may not be downline from the first user based on the second user purchasing and advertising products not associated with the first user. When the first user purchases the product initially advertised by the second user, the second user may be considered upline of the first user after the first user for this product. Because of this, the second user is not relegated to always be downline from the first user just because the first user originally sponsored the second user to become an MLM distributor.

An MLM system which may be referred to as network marketing, may be a business model that depends on person-to-person sales by independent representatives, who may work from their home. A network marketing business may require the independent representatives to build a network of business partners or salespeople to assist with lead generation and closing sales. End of life of MLM tree may refer to the end of the MLM tree in which the commission tree may be restructured or eliminated. For example, further participants in the MLM may not receive a commission, the commission tree may “startup” (be reinitiated from a starting point) again, or the commission tree may be restructured in some other way. An existing MLM system may refer to currently existing or established companies that use the sales strategies to encourage existing distributors to recruit new distributors who are paid a percentage of their recruits' sales.

The administration network computer 110 may perform data security functions as well as functions associated with operation of an MLM algorithm that may calculate user compensation. Administration network computer 110 may be able to connect to a software application store, like the “Apple App Store,” where a program application can be downloaded from. Data security may refer to the process of protecting data from unauthorized access and data corruption throughout its lifecycle. Data security may include data encryption, tokenization, and key management practices that protect data across all applications and platforms. An MLM algorithm may refer to a calculation performed using a compensation decay rate to calculate the commissions for downline participants.

The commission program instructions 120 of FIG. 1 may cause a computer processor in the administration network computer 110 to continuously poll for user data (e.g., data of a user who may be a product purchaser or product distributor) from another processor executing a set of discount program instructions 180 at a third-party network computer 160. Once the processor of the administration network computer 110 receives the user data, it extracts the commission plan associated with the user from a user selection database. The user selection database may be included within the administration database 130 of FIG. 1 or it may be a separate database accessible by the administration network computer 110. Then, commissions may be calculated using the commission program instructions 120 of FIG. 1. These commissions may be calculated based on data stored in an administration network compensation database. Downline and upline commissions for the other users (product purchasers/distributors) within the MLM tree may be paid. The administration network compensation database may be included within the administration database 130 of FIG. 1 or it may be a separate database accessible by the administration network computer 110. Alternatively, instead of the administration network computer 110 polling a third-party network computer 160, the third-party network computer 10 may send the user data to the administration network computer 110 after a sale has been made.

An upline may refer to the MLM distributors that recruits work for as salespeople to sell the products or services. A downline may refer to the recruits the MLM distributors are able to secure as participants in the MLM system. Downline MLM trees may go across country boundaries and commissions may be paid out for an MLM tree even though the participants in the MLM tree may not reside in the same country. The commissions may be calculated for the appropriate exchange rate to ensure participants are paid in their residing countries currency in the correct amount.

A processor executing the commission program instructions 120 of FIG. 1 may continuously poll for user data from the third-party network computer 160. The administration network computer 110 may then receive the user data from the third-party network computer 160. Then the administration network computer 110 may determine whether the user entered a code. If the user did enter a code, the processor at the administration network computer 110 may extract the code and then access the administration network compensation database to identify one or more different spheres of influence or potential product purchasers/distributors levels. Such a code may have been received from user device 140 based on user inputs.

The processor at the administration network computer 110 may also associate a code for each of the different spheres of influence. The administration network computer 110 may then extract a corresponding commission for the code that was retrieved from in the administration network compensation database. The administration network computer 110 may then send the commission to the user (purchaser/distributor). The administration network computer 110 may track profits and payments as well as track taxes for users enrolled in the MLM system. The tracking of profits and payments may refer to the MLM system tracking the profits of the MLM and tracking the payments or commissions paid out to participants. The tracking of taxes may refer to tracking the commissions provided to participants for tax purposes. Then the administration network computer 110 may also compare the extracted code to data stored at an administration network code database a list of users and code sent to followers may be stored. This administration network code database may be the same database as the administration database 130 of FIG. 1 or it may be another database accessible by the administration network computer 110. The administration network code database may include a token code database 135. The administration network computer 110 may extract a user ID and sphere of influence or potential purchaser/distributor by using the extracted code.

The administration network computer 110 may then compare the extracted sphere of influence or potential purchaser/distributor to data stored at the administration network compensation database. The administration network computer 110 may then use the extracted sphere of influence data to extract a corresponding commission from the administration network compensation database. The administration network computer 110 may then send the commission to an upline user. If the user did not enter a code, the administration network computer 110 may then initiate a set of administration network advertising program instructions.

The gambling program instructions 125 of FIG. 1 may cause a computer processor in the administration network computer 110 to poll for a token code from the user device 140. The token code may be stored on a scannable physical token, a virtual code, any combination thereof, or the like. The token code may be entered via an application or web portal accessible by user device 140. Gambling program instructions 125 may compare the entered token code to one or more codes contained in token code database 135 and search for a matching code. In some instances, if a matching code exists in token code database 135, then the entered token code is valid. In some instances, if a matching code does not exist in token code database 135, then the entered token code is invalid. The entered token code may be associated with one or more downline or upline users and/or one or more commission plans. The entered token code, if valid, may discount an associated intangible product and initiate distribution of one or more commissions to the one or more downline or upline users.

Gambling program instructions 125 may send the token code and/or the associated users to the administration network computer 110 to distribute appropriate commissions. The discount may be a percentage off the total cost of the intangible product (i.e., 1-100% discount) and/or may include other promotional deals associated with the intangible product. Gambling program instructions 125 and/or token database 135 may generate a new, unique token code associated with the purchaser of the intangible product.

The administration database 130 may store data received from various third parties (various sellers) that are part of a set of MLM trees. This data may contain a product ID, description of the item, an original cost of the item, a discount for the item, a cost of the product with the discount, a compensation plan decay rate, and a link to the item. An advertising link may refer to a link that directs a consumer to a product, service or good.

TABLE 1
Administration Database Data

| | | | |
|---|---|---|---|
| third-party | Home Depot | Home Depot | Furniture Store |
| ID | 654123 | 789654 | 123789 |
| Item | Drill | Table Saw | Couch |
| Original Cost | $59.00 | $119.00 | $999.00 |
| discount | 15% | 10% | 10% |
| discount Cost | $50.15 | $107.10 | $899.10 |
| Compensation | 50% | 50% | 30% |
| Decay Rate | | | |
| Link | HDDrill654123 | HDTSaw789654 | FSC123789 |

Table 1 table displays data that may be stored at the administration database 130 of FIG. 1. When the administration network computer 110 receives product data from third-party network computer 160 it creates a link for the item, stores the received data in the administration network administration database 130, and sends the created link back to the third-party network computer 160. The administration network administration database 130 may be used to store data collected from various third parties that enrolled in the multi-level marketing system 100 of FIG. 1. The administration network administration database 130 may store the name of the third-party, the ID for an item, a description of the item, the original cost of the item, the discount provided by the third-party, the cost of the product with the discount, the compensation decay rate or how the downline commissions are calculated, and the link to the item.

The administration database 130 may store data that the administration network computer 110 may access when communicating events with the downlines and uplines, providing dynamic incentives or rewards for a product, distributing marketing materials, providing banking referrals, or distributing materials for suggestive selling, etc. Here, communicating events with downlines and uplines may refer to sending information relating to advertising events to participants of an MLM system. Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommends a product which might suit the client.

Token code database 135 of FIG. 1 may store in memory one or more token codes associated with respective users. The administration network computer 110 executing the gambling program instructions 125 may poll token code database 135 for token codes. Token code database 135 may be part of the administration database 130 or it may be a separate database accessible by the administration network computer 110 and/or gambling program instructions 125. Token code database 135 may also be integrated into the administration network code database of administration network computer 110. The administration network computer 110 may poll for a token code from the user device 140. The token code entered from the user device 140 may be associated with a user and that association may be stored in token code database 135. Token code database 135 may be accessible by administration network computer 110 and/or gambling program instructions 125. Token code database 135 may associate stored token codes with physical counterparts, such as scannable barcodes.

As mentioned above user device 140 may include a memory, a processor, and a communication interface 150. The processor of user device 140 may execute instructions out of the memory when a user of user device 140 registers as a member of an MLM organization. Other tasks that a user may perform on user device 140 could include, identifying or connecting with other user devices (e.g., follower user devices), preparing advertisement information to share with follower user devices, receiving advertisement information prepared by other users, accessing product promotions at the third-party network computer 160, and purchasing products based on offerings received from the third-party network computer 160. Each of the tasks performed by user device 140 may include sending and receiving communications with the administration network computer 110, the third-party network computer 160, or other user devices. Promotions prepared at a particular user device may be shared with other user device via administration network computer 110, third-party network computer 160, a social media network computer, or directly from one user device to another. User devices may also be required to download and install an application program from an application store, such as the “Apple App store” as part of a process for registering as a member of an MLM organization.

The user device communication interface 150 of FIG. 1 may send and receive data via a communication network 190 which may be a wired and/or a wireless network.

As discussed above the third-party network computer 160 of FIG. 1 may include a computer processor, a memory, and communication interface 170. This third-party network computer 160 may be controlled by various third parties, such as retail stores (stores that sell products, services, franchises, service networks, large box stores), e-commerce sites that allow e-commerce sales, online casinos or betting websites, any combination thereof, or the like. Such betting websites may include a wager shopping cart of various wagers, that offer the wagers to users at a discount, such as a free wager, in order to use the MLM system of FIG. 1. A franchise may refer to an authorization granted by a government or company to an individual or group enabling them to carry out specified commercial activities, e.g., providing a broadcasting service, or acting as an agent for a company's products. E-commerce sale may refer to sales of goods and services where the business takes place over the internet, an extra-net, Electronic Data Interchange (EDI), or other online system. Online casinos may refer to brick-and-mortar casinos that operate an online gambling website, application, etc. in conjunction with the brick-and-mortar operation and the online website may offer games of chance, including, but not limited to, slots, roulette, poker, blackjack, etc. Online casinos may also refer to a solely online casino. Betting websites may refer to sites that facilitate betting, calculate odds, and/or pay out winnings for users based on sports or other activities.

Payment may or may not be made online. Business in this context may be defined as an order placed by the buyer or price and terms of sale negotiated. E-commerce shopping cart may refer to a software used in E-commerce to assist visitors to make purchases online. Upon checkout, the software calculates the total of the order, including shipping and handling, taxes and other parameters the owner of the site has previously set. Retailer may refer to a person or business that sells goods to the public in relatively small quantities for use or consumption rather than for resale. Product discounts may refer to a reduce price or something being sold at a price lower than that product is normally sold for. It is a reduction to a basic price for a good or service. Large box stores may refer to a physically large retail establishment, usually part of a chain of stores, offers a variety of products to its customers. The term sometimes refers, by extension, to the company that operates the store, and which may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance.

The third-party network communication interface 170 of FIG. 1 may send data and receive via a communication network 190 which may be a wired and/or a wireless network.

The third-party network discount program instructions 180 of FIG. 1 may be executed by a computer processor after being initiated by a set of third-party network base program instructions. These instructions may cause the processor at the third-party network computer 160 to prompt user for a discount code and to compare a received code to data stored at a third-party network third-party database. When a code received from a user matches data stored at the databases, a discount for the selected product may be applied and an order for a product may be processed.

The communications network 190 of FIG. 1 may be the Internet or a cloud. This communication network or any of the communication network interfaces 150 or 170 discussed herein may be a wired and/or a wireless network. Such a communication network, if wireless, which may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

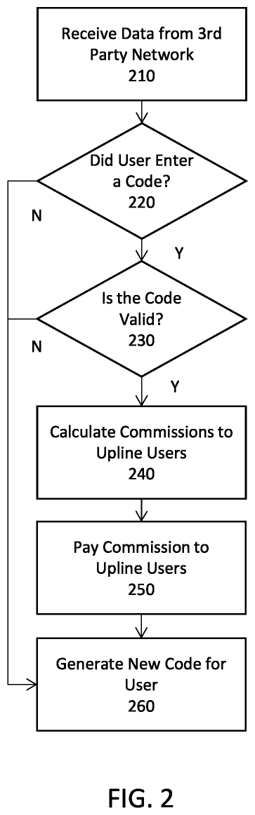

FIG. 2 illustrates steps 200 that may be performed by a computer that performs functions consistent with the administration network computer 110 of FIG. 1. FIG. 2 begins at step 210 wherein the administration network computer 110 receives data from the third-party network computer 160 of FIG. 1. The received data may contain information on a purchased product and the discount code applied to the purchase. This step may be facilitated by a set of administration network base program instructions stored in memory and executed by a processor. The administration network computer 110 may determine if the data received from the third-party network computer 160 contains a code, at step 220. If the data does contain a code, the administration network computer 110 checks that both the product and code match data stored in the administration network administration database 130 and/or other databases and are recognized as valid, at step 230. If the code and product are valid, the computer at administration network computer 110 may calculate commissions due to each upline user, at step 230.

As an illustrative example, the commissions may be calculated by using the discount on the product and providing 50% of the discount to the user who supplied the code and then the remaining amount of the discount for the upline users at a 50% decay rate. For example, if the first user purchased a product that was originally $59.00 discounted by 15%, then a second user makes a purchase with the first user's code would receive $3.32 or 50% of the discount. Then any follower of the second user who uses the second user's code would cause the second user to receive 50% of the discount and the first user to receive 50% of the remaining discount or 50% of $3.32, and this may continue until there is only one cent left to pay out as a commission for the upline users. The threshold at which commission stops may be greater or less than one cent and may be set dynamically. This step may be facilitated by administration network calculation program instructions stored in memory and executed by a processor. Then, the administration network computer 110 may distribute the commission to the upline users, at step 250. Commission may be paid directly to a user via the user device 140 of FIG. 1. The data may be stored in a database, for example, an administration network compensation database discussed above. Whether or not a valid code was entered, the administration network computer 110 may generate a new code for the user such that the user can give the code to followers and receive commission on their purchases, at step 260 of FIG. 2. This generated code may be stored in the administration database 130 of FIG. 1 or another database, for example an administration network code database.

A set of administration network base program instructions may instruct the administration network computer 110 to connect to the third-party network computer 160, initiate a set of vendor program instructions and initiate a set of calculation program instructions.

A set of administration network calculation program instructions which may be initiated by operation of the administration network base program instructions may instruct the administration network computer 110 to extract the discount received from the third-party network computer 160 as well as the compensation plan or commission plan (e.g. its decay rate or commission structure so that each downline gets less and less commission) in order to identify the commissions for the MLM (Multi-Level Marketing) tree. Once identified, this commission data may be stored data in a database at the administration network computer 110 of FIG. 1. A commission may refer to a payment to someone who sells goods that is directly related to the amount sold, or a system that uses such payments. A compensation plan or a commission plan may refer to the decay rate of the commissions provided to the MLM system from the discount offered by the third-party, the third-party also selects the decay rate to calculate the commissions offered to the first purchaser as well as the percentage offered to the downline participants.

Functioning of the calculation program instructions may be as follows. The process may begin with operations of the administration network base program instructions initiating the administration network calculation program instructions. The administration network computer 110 may then extract the discount from the administration network administration database 130, which may be received from the third-party network computer 160. Then the administration network computer 110 may extract the compensation plan decay rate from the administration network administration database 130. The administration network computer 110 may then determine the commissions available to the downline users, or the followers of the user that purchased the item.

As an illustrative example, the commissions may be calculated by using the discount on the product and providing 50% of the discount to the first participant and then the remaining amount of the discount for the downline users at a 50% decay rate. For example, if the first user purchased a product that was originally $59.00 discounted by 15%, the first user to make the purchase would receive $3.32 or 50% of the discount. Then any follower of the user who made the initial purchase would receive 50% of the remaining discount or 50% of $3.32, and this may continue until there is only one cent left to pay out as a commission for the downline users. Then the administration network computer 110 stores the data in the administration network compensation database. The administration network computer 110 sends a request to the user device purchase program instructions for the data stored in the user device user database. Then the administration network computer 110 may receive the user device user database data from the user device 140. The administration network computer 110 may store the received data, as well as the code data, in the administration network code database. The administration network computer 110 may then return to executing the administration network base program instructions.

A set of administration network advertising program instructions, which may be initiated by operation of the administration network commission program instructions 120, may determine the user's sphere of influence or contact list in order to provide the user's potential downline purchasers/distributors with a link and a code for the potential downline purchasers/distributors to become part of the MLM Tree Functioning of the advertising program instructions may be as follows. The process may begin with operation of the administration network commission program instructions 120 causing the administration network computer 110 to initiate the administration network advertising program instructions. The administration network computer 110 then determines if the user entered a code. If it is determined that the user entered a code the code is extracted. The administration network computer 110 compares the extracted code to the administration network compensation database.

The administration network computer 110 then may determine the user's sphere of influence level. If it is determined that the user did not enter a code, then the administration network computer 110 sets the user as the “First Participant”. Then the administration network computer 110 extracts the code for the next sphere of influence level or potential purchaser/distributor to provide the user's followers with a code that would allow them to join the multi-level marketing tree. The administration network computer 110 then may send the code and the link to the product to the user device 140. A set of administration network vendor (those selling products) program instructions, which may be initiated by operation of the administration network base program instructions, may result in data being received from the third-party network computer 160. The administration network computer 110 may then store the data in the administration network administration database 130, create a link for the item, send the link back to the third-party network 160, and return to executing the administration network base program instructions.

Functioning of a set of vendor program instructions may be as follows. The process may begin with operation of the administration network base program instructions causing the administration network computer 110 to initiate the administration network vendor program instructions. The administration network computer 110 may then receive data from the third-party network computer 160. This data may include a product to be enrolled in the MLM system, an original cost of the item, a discount provided by the third-party, a cost of the product with the discount, a compensation plan decay rate, etc. Then the administration network computer 110 may create a link for the product for the third-party network computer 160. A vendor may be a seller of a product, such as a retailer. The administration network computer 110 may then store the received data and the created link in the administration network administration database 130. The administration network computer 110 may then send the link to the third-party network computer 160. The administration network computer 110 may then return to executing the administration network base program instructions.

An administration network compensation database, which may be created through operation of the administration network calculation program instructions, may store various commissions for the different product purchasers/distributors. Table 2 illustrates data that may be stored at a compensation database consistent with the present disclosure. The administration network computer 110 may extract discount information and a compensation plan decay rate to calculate the downline commissions for additional users. This discount, decay rate information, and the sphere of influence levels may be stored in the administration network compensation database discussed above. The administration network compensation database may store information that cross-references a third-party, a product ID, product description, the compensation plan decay rate, the various sphere of influence levels, a commission for each sphere of influence level, and a code to be used by the user's followers to enroll in the MLM system 100 of FIG. 1. The administration network compensation database may store a lottery structure for how the commissions are paid to users or freelancers. This lottery structure may refer to a process or thing whose success or outcome is governed by chance. A means of raising money by selling number tickets and giving prizes to the holders of number drawn at random. Freelancers may refer to a person who works as a writer, designer, performer, or the like, selling work or services by the hour, day, job, etc., rather than working on a regular salary basis for one employer.

TABLE 2
Compensation Database Data

| | | | |
|---|---|---|---|
| third-party | Home Depot | Home Depot | Home Depot |
| ID | 654123 | 654123 | 654123 |
| Item | Drill | Drill | Drill |
| compensation Decay | 50% | 50% | 50% |
| Rate | | | |
| Sphere of Influence | First | 2 | 3 |
| Level | Participant | | |
| Commission | $3.31 | $1.66 | $0.83 |
| Code | N/A | 654123- | 654123- |
| | | SOI2 | SOI3 |

Table 3 illustrates data that may be store at an administration network code database. This data may identify the codes given to the product purchasers/distributors (users) for the product purchasers/distributors (user) to pass to their potential purchasers/distributors to advertise or promote a product that a user has purchased. The administration network code may also cross-reference a user ID with a product ID, a product name, a sphere of influence (/potential purchaser/distributor), and a code that may be shared with followers.

TABLE 3
Code Database Data

| | | | Sphere of Influence/ | |
|---|---|---|---|---|
| | | | potential | code for |
| user ID | ID | Item | purchaser/distributor | Followers |
| JS1234 | 654123 | Drill | First Participant | 654123-SOI2 |
| HY8569 | 654123 | Drill | Second Participant | 654123-SOI3 |
| TB4567 | 789654 | Table | First Participant | 897456-SOI2 |
| | | Saw | | |
| EL51346 | 789654 | Table | Second Participant | 897456-SOI3 |
| | | Saw | | |

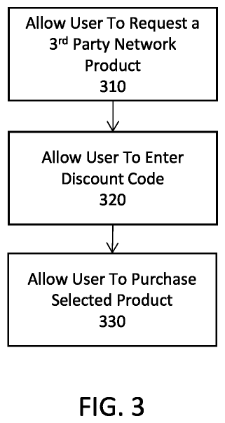

FIG. 3 illustrates operations 300 that may be performed at a user device when operations of a multi-level marketing system 100 of FIG. 1 are performed. First the user device 140 may allow a user to request to purchase a product from the third-party network computer 160, at step 310 of FIG. 3. This may involve directing the user to a web site or an online store. A link stored in the administration network administration database 130 may be used to automatically generate a request to purchase of a specific product. Then the user device 140 may then allow the user to enter a discount code, at step 320. The code may be entered automatically if the user selected a link received from the administration network computer 110. The user may enter the discount code in a graphical user interface (GUI) element such as a text box or input box, either via a native application on the user device 140 or directly via the third-party network computer 160 (for example, via a web browser). The user device 140 may then allow the user to finalize an order, at step 330. This step may involve the transfer of payment information from the user device 140 to the third-party network computer 160. Any or all these steps may be facilitated by user device communication interface 150, user device purchase program instructions stored in memory and executed by a processor, or a user device user database stored in memory.

A set of instructions referred to as user device purchase program instructions may allow a user device to connect to the third-party network computer 160, allow a purchaser/distributor to select a product and an associated link. This process may include, determining if the purchaser/distributor entered a code, and sending the link and code, if available, to the third-party network computer 160.

A set of instructions referred to as purchase program instructions may cause the user device 140 to continuously poll for a request from the administration network computer 110 for user device user database data. The user device 140 may then receive a request from the administration network computer 110 for the user device user database data. Then, the user device 140 may send the user device user database data to the administration network computer 110. The user device 140 may then connect to the third-party network computer 160. Then the user may select a product from the third-party network computer 160. The user may select a link from the third-party network computer 160. Then the user device 140 if the user entered a code. If it is determined the user entered a code the user device 140 sends the code to the third-party network computer 160. The user device 140 sends the user data to the third-party network computer 160. The user data may be data to purchase the product such as name, address, billing information, etc. The user data sent to the third-party network computer 160 may include information from a credit card system. A credit card system may refer to a system that allows cardholders to borrow funds with which to pay for goods and services with the condition that the cardholders pay back the borrowed funds, plus interest, as well as any additional agreed-upon charges.

A user device user database which may contain the user's (product purchasers/distributors) followers (sphere of influence) as well as the followers contact information for them to receive commissions on their purchases. A distributor contact list or followers may refer to the recruits or followers on social media that a distributor has secured to participate in their downline. The user device user database may include ratings and recommendations from the users. Rating and recommendation modules may refer to modules in which a company, entity, or person provides ratings and/or recommendations for products, goods, or services.

Table 4 displays data that may be stored at a user device user database. The data of table 4 cross-references user information with user follower information. The user device user database stores the user's ID, the followers user ID, codes provided to the followers, the follower's e-mail address, the follower's phone number, and the follower's address. The user device user database may store the follower's social media information such as user social media account information (Twitter, Instagram, Facebook, etc.). The user database may contain social media plug-ins for enhanced marketing or social media aggregators. Social media plug ins for enhanced marketing may refer to sharing content with other people through social media platforms, for example a share or like button. The user device user database may contain payment information such as bank accounts, credit card information, PayPal, Venmo, etc. A user ID or ID Enrollment may refer to a participant enrolling in an MLM product tree through an ID, which may be unique to each participant in the MLM system. Social media aggregators may refer to a tool that allows a person to collate posts and updates from many different social media feeds. It creates an organized view of social posts on a specific topic and are often used to display user-generated content on live social walls.

TABLE 4
User Database Data

| | | | |
|---|---|---|---|
| user ID | JS1234 | JS1234 | JS1234 |
| Follower ID | HY8569 | IT8527 | RW4569 |
| code for | 654123-SOI2 | 654123-SOI2 | 654123-SOI2 |
| Followers | | | |
| Follower E-mail | HY8569@gmail.com | IT8527@yahoo.com | RW4569@gmail.com |
| Follower Phone | 781-654-8972 | 231-456-7891 | 654-987-3217 |
| Follower | 123 Main Street, | 58 Elm Street, | 96 2nd Ave, Salt |
| Address | Boston, MA | Burlington, VT | Lake City, UT |

Operation of user device downline program instructions may cause the user device 140 to continuously poll to receive the code and link from the administration network computer 110 to allow the purchaser/distributor to pass the code and link to the user's followers stored in the user device user database. Functioning of the downline program instructions may be as follows. The process begins with the user device 140 continuously polling for the code and the link from the administration network computer 110. The user device 140 receives the code and the link from the administration network computer 110. The user device 140 provides a selection of the first follower in the user device user database. The user device 140 extracts the follower's contact information stored in the user device user database. Then the user device 140 sends the code and link to the follower's contact information. The code and link may be shared on social media sites, such as Twitter, Instagram, Facebook, etc. This may allow the user's followers to receive the code and link based on communications that use one or more of these social media accounts. The user device 140 may then determine if there are more followers remaining in the user device user database. If it is determined that there are more followers stored in the user device user database, the user device 140 selects the next user stored in the user device user database. If the user device 140 determines that there are no more followers remaining in the user device user database, then the process ends.

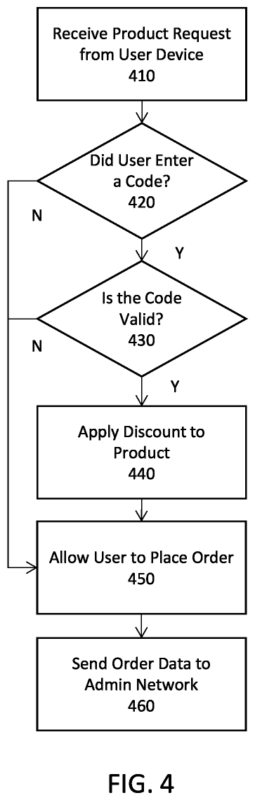

FIG. 4 illustrates steps 400 that may be performed by a computer at the third-party network computer 160 of FIG. 1. FIG. 4 begins with step 410 wherein the third-party network computer 160 receives a request from a user device 140 to purchase a product. This request may be facilitated by a public facing webpage, for example, an online store page for the third-party retailer that controls the third-party network computer 160. The third-party network computer 160 then may identify if the user entered a code, at step 420. Here, the code may be entered prior to a request for purchase. For example, before checking out using an online shopping cart the user may be able to enter discount codes. If a code was entered, the third-party network computer 160 may identify whether the code is recognized as a valid code for receiving a discount, at step 430 of FIG. 4.

The code may be retrieved from the administration network computer 110 via the third-party network communication interface 170. Codes may be stored locally on the third-party network computer 160 or in a third-party network third-party database accessible by the third-party network computer. If the code is valid, the third-party network computer 160 applies a discount to the item, at step 440. An amount associated with this discount may be retrieved by the administration network computer 110 via the third-party network communication network interface 170. Discount amounts may be stored locally at a third-party network database. The third-party network computer 160 may then allow the user to finish placing the order for the item, at step 450 of FIG. 4. The third-party network computer 160 may then send some or all the data on the purchase, including the discount code if one was provided, to the administration network computer 110, at step 460. Any or all these steps may also be facilitated by execution of different sets of program instructions that may include third-party network base program instructions and third-party network administration program instructions.

A third-party network computer 160 may execute administration program instructions to cause the third-party network computer to connect to the administration network computer 110, send the data for the items to be purchased, receive a link from the administration network computer 110, store the link in a third-party network database, and return to executing a set of base program instructions. The process may begin with the third-party network computer 160 administration program instructions being initiated by the third-party network base program instructions. The third-party network 160 may connect to the administration network computer 110 and then the third-party network computer 160 may send third-party network database data to the administration network computer 110. Then the third-party network computer 160 may store the link in the third-party network third-party database.

Operation of a third-party network discount program instructions 180 may include extracting a link sent by the user device 140 and comparing it to data stored at the third-party network third-party database. This may result in the identification of a corresponding discount for a selected item. This process may include identifying whether a user entered a code or not, after which a discount is applied, and the order is processed.

The process of applying a discount may begin by extracting the link received from the user. Then the third-party network computer 160 may compare data included in the extracted link to data stored at the third-party network database. The third-party network computer 160 may then extract a corresponding discount from the third-party network third-party database. Then the third-party network computer 160 may apply the extracted discount to the user's order. The third-party network computer 160 may then determine if the user entered a code. If it is determined that the user did not enter a code the third-party network computer 160 sends the user data to the administration network computer 110 without a code. If it is determined that the user entered a code the third-party network computer 160 sends the code and the user data to the administration network computer 110. Next the third-party network computer 160 may process the user's order.

A third-party network third-party database may store information about the items that may be purchased. This third-party network database may include local media for the product or service, where this local media may refer to the various types of media, such as photos, videos, text, sounds, haptics, online product descriptions, etc. for enhanced marketing.

Table 5 illustrates data that may be stored at a third-party database. This data may include information about the items enrolled in the MLM system as well as a link created by execution of the administration network vendor program instructions. The third-party network database may cross-reference a product ID, a product description, an original cost of the item, a discount provided by the third-party for the item, a cost of the product with the discount, a compensation plan decay rate which the third-party enters, and a link received from the administration network computer. The third-party network third-party database may include the rates of exchange for product returns, marketing materials, airline sky miles, etc. Product returns may refer to a process in which a customer or consumer takes previously purchased product, merchandise, or goods back to the retailer, and in turn receive a refund in the original form of payment, exchange for another product (identical or different), or a store credit.

The information about the product or service which may be advertisements to the network, or as seen on TV sales. Advertisements to the network may refer to the advertisement provided to the MLM system from the third-party offering a product, good or service. These as seen on TV sales may refer to a generic nameplate for products advertised on television in the United States for direct response mail-order through a toll-free telephone number. Marketing materials may refer to a means of marketing, advertising or promotional materials developed by or for license (or subject to licensee's approval) that promote the sale of the licensed product, including but not limited to, television, radio, and online advertising, point of sale materials (e.g., posters, counter-cards), packaging advertising, print media and all audio or video media. Airline sky miles may refer to a loyalty program offered by airlines and/or credit cards. Typically, consumers accumulate a set amount of miles based on how much is spent on a ticket or a credit card and are also known as frequent flyer miles or travel points.

TABLE 5
Third-Party Database Data

| | |
|---|---|
| ID | 654123 |
| Item | Drill |
| Original Cost | $59.00 |
| Discount | 15% |
| Discount Cost | $50.15 |
| Compensation Decay | 50% |
| Rate | |
| Link | HDDrill654123 |

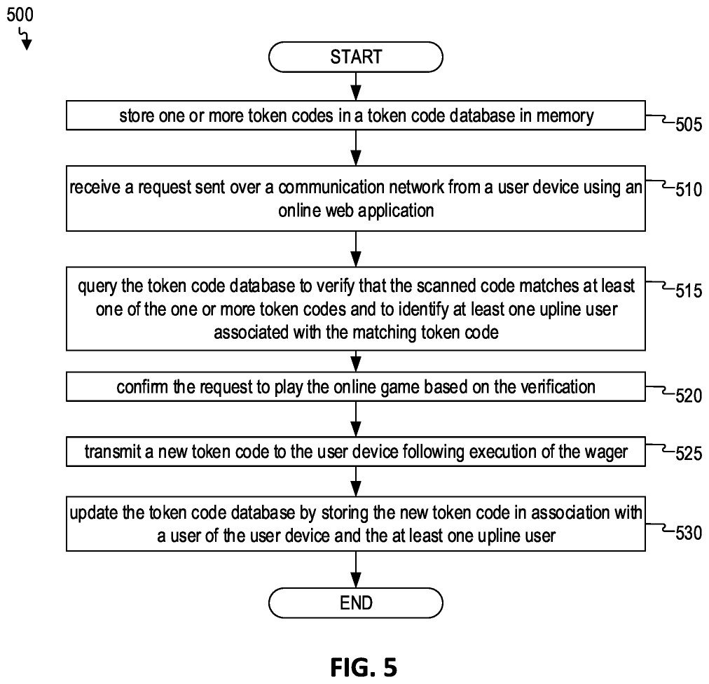

FIG. 5 illustrates a method that may be performed by the administration network computer 110 executing the gambling program instructions 125 of FIG. 1 and illustrates an example method 500 for integrating games of chances into a waves of commission marketing system. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some examples, the method includes storing one or more token codes in a token code database in memory at block 505. For example, the administration network computer executing the gambling program instructions illustrated in FIG. 1 may store one or more token codes in a token code database in memory. The one or more token codes are associated with one or more users and wager amounts.

TABLE 6
Token Code Database Data

| | | | Sphere of Influence/ | | Scannable Bar |
|---|---|---|---|---|---|
| | | | potential | Token Code | Code |
| user ID | ID | Item | purchaser/distributor | for Followers | Number |
| JS1234 | 654123 | Prize Wheel | First Participant | 654123-SOI2 | 1587-69456 |
| | | (Single | | | |
| | | Spin) | | | |
| HY8569 | 654123 | Prize Wheel | Second Participant | 654123-SOI3 | 3654-48753 |
| | | (Single | | | |
| | | Spin) | | | |
| TB4567 | 789654 | Slot | First Participant | 897456-SOI2 | 3497-12478 |
| | | Machine | | | |
| | | ($5) | | | |
| EL51346 | 789654 | Slot | Second Participant | 897456-SOI3 | 3216-47523 |
| | | Machine | | | |
| | | ($5) | | | |

Token code database 135 may be part of the aforementioned administration database or it may be a separate database accessible by the administration network computer executing the gambling program instructions. The token code database may also be integrated into the administration network code database of the administration network computer. The administration network computer may poll for a token code from a user device. The token code entered from the user device may be associated with a user and that association may be stored in token code database. The token code database may associate stored token codes with physical counterparts, such as scannable barcodes.

Table 6 illustrates data that may be store at the token code database. This data may identify the token codes given to the product purchasers/distributors (users) for the intangible product purchasers/distributors (user) to pass to their potential purchasers/distributors to advertise or promote a product that a user has purchased. The token code may also cross-reference a user ID with a product ID, a product name, a sphere of influence (/potential purchaser/distributor), a scannable bar code, and a code that may be shared with followers. The items illustrated in Table 6 may vary depending on the type of game of chance associated with the item. For example, for a prize wheel game, the intangible product may be a single spin, but for games like craps or blackjack, there may be different intangible products at different wager amounts.

According to some examples, the method includes receiving a request sent over a communication network from a user device using an online web application at block 510. For example, the administration network computer executing the gambling program instructions illustrated in FIG. 1 may receive a request sent over a communication network from a user device using an online web application. The online web application may be an installed application on a computer or cell phone, a web site, a kiosk, any combination thereof, or the like. The request concerning play of an online game and associated with a scanned code. The user device may be associated with a user who is new to the MLM program or is an existing member. The user may request to purchase an intangible product, like a spin of a prize wheel, and may have received a token code from a second user. The token code may be entered at the online web application via the user manually entering the token, which may be any combination of letters, numbers, and/or symbols, or the token code may be scanned on a scannable token that carries scannable data. The scanned code may be embedded in a bar code, QR code, or any other scannable code.

According to some examples, the method includes querying the token code database to verify that the scanned code matches at least one of the one or more token codes and to identify at least one upline user associated with the matching token code at block 515. For example, the administration network computer executing the gambling program instructions illustrated in FIG. 1 may query the token code database to verify that the scanned code matches at least one of the one or more token codes and to identify at least one upline user associated with the matching token code. The administration network computer or gambling program instructions may receive the scannable code entered by the user on the user device and may compare the scanned code to the one or more token codes stored in the token code database. If there is no code in the token code database that matches the scanned code, the program may return a notification to the user device and/or via the online web portal indicating that the scanned code is invalid.

Further, the method comprises identifying the at least one upline user and at least one commission rate associated with the at least one upline user. For example, the administration network computer executing the gambling program instructions illustrated in FIG. 1 may identify the at least one upline user and at least one commission rate associated with the at least one upline user. The token code may be associated with one upline user who gave the token code to the user. There may exist one or more additional upline users who are also associated with the token code but may be in higher “tiers” of the MLM system.

Further, the method comprises calculating a commission for the at least one upline user. For example, the administration network computer executing the gambling program instructions illustrated in FIG. 1 may calculate a commission for the at least one upline user. The upline user(s) associated with the token code may each be associated with corresponding commission plans. The commission plans may determine the benefit received by the upline user(s) in response to the user entering the scanned code. The commission may be monetary, credit, or any other type of renumeration.

Further, the method comprises notifying the at least one upline user of the calculated commission. For example, the administration network computer executing the gambling program instructions illustrated in FIG. 1 may notify the at least one upline user of the calculated commission. The notification may be via an online messaging system, e-mail, text message, a monthly statement, any combination thereof, or the like. The notification may only need to give notice to the upline user(s) in a reasonable manner of the calculated commission.

According to some examples, the method includes confirming the request to play the online game based on the verification at block 520. For example, the administration network computer executing the gambling program instructions illustrated in FIG. 1 may confirm the request to play the online game based on the verification. Confirming includes determining an amount of a wager of the request to play the online game, wherein the amount may be a cost. Verification may be complete when the scanned code has been matched to a code stored in the token code database and the upline and downline user(s) associated with the scanned code have been identified. The confirmation may be communicated to the user via a notification on the user device and/or via the online web application. The confirmation indicates that the scanned code has been matched with at least one code in the token code database and that the user may continue to purchase the intangible product, such as a wager.

Further, the method comprises modifying the amount of the wager according to a benefit associated with the scanned code. For example, the administration network computer executing the gambling program instructions illustrated in FIG. 1 may modify the amount of the wager according to a benefit associated with the scanned code. The benefit is a discount, a coupon, a multiplier, or a bonus. The online web application, via the user device, may execute a discount on the wager or intangible product automatically upon confirmation of the request. The discount may be a percentage off the monetary cost of the wager or intangible product (e.g., 50% off a spin on a prize wheel), a free entry into a game of chance (e.g., one free turn on a slot machine), a promotion (e.g., buy one wager, get another wager free), a multiplication of winnings (e.g., earn double the winnings on this spin of a prize wheel), or any other similar incentive to purchase an entry into a game of chance. After modification, the wager may be executed. Execution of the wager may refer to placing the wager, winning the wager, losing the wager, or some other real-world event.

According to some examples, the method includes transmitting a new token code to the user device following execution of the wager at block 525. For example, the administration network computer executing the gambling program instructions illustrated in FIG. 1 may transmit a new token code to the user device following execution of the wager. The new token code is associated with a user ID. The user ID may be associated with the user associated with the user device. The user may utilize the new token code as a method of obtaining downline users associated with the new token code. The token code may be embedded onto a scannable token with a scannable representation of the new token code. The new token code may also be embedded in a link that may take a new user to the website or online web application where the online interaction may occur and be detected.

Upon generating a new token code, the administration network computer or gambling program instructions may request from the user a commission plan selection. The user may make the selection at the time of issuance for the new token code or may make the selection at a later date. The administration network computer or gambling program instructions may make the selection automatically, wherein the administration network computer or gambling program instructions may reference a “default” commission plan that will be automatically enacted upon the generation of the new code. The user may be able to change the commission plan at least once.

According to some examples, the method includes updating the token code database by storing the new token code in association with a user of the user device and the at least one upline user at block 530. For example, the administration network computer executing the gambling program instructions illustrated in FIG. 1 may update the token code database by storing the new token code in association with a user of the user device and the at least one upline user. The new token code and all related data may be stored in the token code database for reference in future transactions. If a new user inputs the new token code, the new token code may be associated with the user and may allocate commissions accordingly. The new token code may be associated with all upline user(s) of the token code, and that data may be stored in the token code database.

FIG. 6 illustrates a computing system that may be used to implement an embodiment of the present invention. The computing system 600 of FIG. 6 includes one or more processors 610 and main memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 670, user input devices 660, a graphics display 670, peripheral devices 680, and network interface 695.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a FLASH memory, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 670. Examples of suitable output devices include speakers, printers, network interfaces, and monitors.

Display system 670 may include a liquid crystal display (LCD), a plasma display, an organic light-emitting diode (OLED) display, an electronic ink display, a projector-based display, a holographic display, or another suitable display device. Display system 670 receives textual and graphical information and processes the information for output to the display device. The display system 670 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 680 may include any type of computer support device to add additional functionality to the computer system. For example, peripheral device(s) 680 may include a modem or a router.

Network interface 695 may include any form of computer interface of a computer, whether that be a wired network or a wireless interface. As such, network interface 695 may be an Ethernet network interface, a Bluetooth™ wireless interface, an 802.11 interface, or a cellular phone interface.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 600 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

What is claimed is:

1. A computer-implemented method for code-based tracking of online gaming token usage, the method comprising:
storing one or more token codes in a token code database in memory, wherein the one or more token codes are associated with one or more users and online wager amounts;
receiving a request sent over a communication network from a user device using an online web application, the request concerning play of an online game and associated with a scanned code;
querying the token code database to verify that the scanned code matches at least one of the one or more token codes and to identify at least one upline user associated with the matching token code;
confirming the request to play the online game based on the verification, wherein confirming includes determining an amount of an online wager in the request to play the online game;
transmitting a new token code to the user device following execution of the online wager and play of the online game; and
updating the token code database by storing the new token code in association with a user of the user device and the at least one upline user.

2. The method of claim 1, further comprising polling one or more user devices for the scanned code.

3. The method of claim 1, further comprising associating the scanned code with a scannable token that carries scannable data.

4. The method of claim 1, wherein the scanned code is embedded in a bar code.

5. The method of claim 1, wherein the new token code is associated with a user identifier (ID), product, one or more downline users, or an embedded link.

6. The method of claim 1, further comprising:
identifying the at least one upline user associated with the use of the token code in the online game; and
generating a notification to a user device of the at least one upline user identified as being associated with the use of the token code in the online game.

7. The method of claim 1, further comprising modifying the amount of the online wager according to a stored benefit associated with the scanned code, wherein the stored benefit is one or more of online discount, online coupon, a multiplier, or a bonus.

8. A system for code-based tracking of online gaming token usage comprising:
memory that stores one or more token codes in a token code database, wherein the one or more token codes are associated with one or more users and online wager amounts;
a communication interface that communications over a communication network to receive a request sent from a user device using an online web application, the request concerning play of an online game and associated with a scanned code; and
a processor that executes instructions stored in memory, wherein the processor executes the instructions to:
query the token code database to verify that the scanned code matches at least one of the one or more token codes and to identify at least one upline user associated with the matching token code; and
confirm the request to play the online game based on the verification, wherein confirming includes determining an amount of an online wager in the request to play the online game;
wherein the communication interface transmits a new token code to the user device following execution of the online wager and play of the online game; and
wherein the memory updates the token code database by storing the new token code in association with a user of the user device and the at least one upline user.

9. The system of claim 8, wherein the processor executes further instructions to cause the communication interface to poll one or more user devices for the scanned code.

10. The system of claim 8, wherein the scanned code is associated with a scannable token that carries scannable data.

11. The system of claim 8, wherein the scanned code is embedded in a bar code.

12. The system of claim 8, wherein the new token code is associated with a user identifier (ID), product, one or more downline users, or an embedded link.

13. The system of claim 8, wherein the processor executes further instructions to:
identify the at least one upline user associated with the use of the token code in the online game; and
generate a notification to a user device of the at least one upline user identified as being associated with the use of the token code in the online game.

14. The system of claim 8, wherein the processor executes further instructions to the amount of the online wager according to a stored benefit associated with the scanned code, wherein the stored benefit is one or more of online discount, online coupon, a multiplier, or a bonus.

15. A non-transitory computer-readable storage medium, having embodied thereon instructions executable by a computing system to perform a method for code-based tracking of online gaming token usage, the method comprising:
storing one or more token codes in a token code database in memory, wherein the one or more token codes are associated with one or more users and online wager amounts;
receiving a request sent over a communication network from a user device using an online web application, the request concerning play of an online game and associated with a scanned code;
querying the token code database to verify that the scanned code matches at least one of the one or more token codes and to identify at least one upline user associated with the matching token code;
confirming the request to play the online game based on the verification, wherein confirming includes determining an amount of an online wager in the request to play the online game;
transmitting a new token code to the user device following execution of the online wager and play of the online game; and
updating the token code database by storing the new token code in association with a user of the user device and the at least one upline user.
